(19) United States
(12) Patent Application Publication
(10) Pub. No.: US 2009/0184147 A1
(43) Pub. Date: Jul. 23, 2009

(54) Bottle rack for bicycles

(76) Inventor: Yuan Hung Wen, Hemei Township (TW)

Correspondence Address: Chien-Hui Su, P. O. Box 70-121 Taichung, Taichung City, 40899, TW

(21) Appl. No.: 12/010,112

(22) Filed: Jan. 22, 2008

(51) Int. Cl. B62J 11/00

(52) U.S. Cl. 224/461; 248/311.2; 224/414

(57) ABSTRACT

A bottle rack for a bicycle includes a base portion fixed to the bicycle and includes a first portion and a second portion which is located at an angle from the first portion. A substantially U-shaped holding portion includes two ends which are pivotably connected to the base portion so as to hold a bottle between the base portion and the holding portion. The holding portion can be positioned relative to the base portion at two positions, the first position allows the holding portion to be located away from the base portion so as to hold the water bottle, and the holding portion is engaged with the base portion at the second position so as to reduce the space occupied.

### FIELD OF THE INVENTION

The present invention relates to a bottle rack for bicycles and includes a stationary part fixed to the bicycle and a pivotable part which is positioned at different angles.

### BACKGROUND OF THE INVENTION

A conventional bottle-cage device for bicycles is disclosed in U.S. Publication Application 2003/0094556 and includes a base portion and a holding portion, wherein the base portion is fixed to the bicycle frame and the holding portion is substantially a U-shaped part which is fixed to the base portion at two ends thereof and the curved portion is flexible relative to the base portion. A water bottle is retained between the base portion and the holding portion. It is noted that the flexibility of the holding portion is limited so that only the water bottles with a small range of size can be used with the bottle-cage device. Besides, the curved portion of the holding portion is located at a distance from the base portion, so that the holding portion actually protrudes from the base portion and cannot be folded to reduce the space occupied. The holding portion may be hit by the rider's knees or any foreign object and is deformed or broken. Once the holding portion is deformed or broken, it cannot hold the water bottle in position.

The present invention intends to provide a bottle rack for bicycles and the holding portion can be folded toward the base portion so as to reduce space occupied.

### SUMMARY OF THE INVENTION

The present invention relates to a bottle rack for a bicycle and the bottle rack comprises a base portion fixed to the bicycle and including a first portion and a second portion which is located at an angle from the first portion. A holding portion is a substantially U-shaped member and two ends of the holding portion are pivotably connected to the base portion. A bottle is positioned between the base portion and the holding portion.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the bottle rack of the present invention;

FIG. 2 is a perspective view to show the bottle rack of the present invention, wherein the holding portion is at the second position;

FIG. 3 is a side view of the bottle rack of the present invention in FIG. 2;

FIG. 4 shows the bottle rack of the present invention is connected to the bicycle and a water bottle is retained in the bottle rack;

FIG. 5 shows the holding portion of the bottle rack of the present invention is pivoted relative to the base portion to hold bottles of different sizes, and

FIG. 6 is an exploded view to show another embodiment of the bottle rack of the present invention.

### DETAILED DESCRIPTION OF THE PREFERRED EMBODIMENT

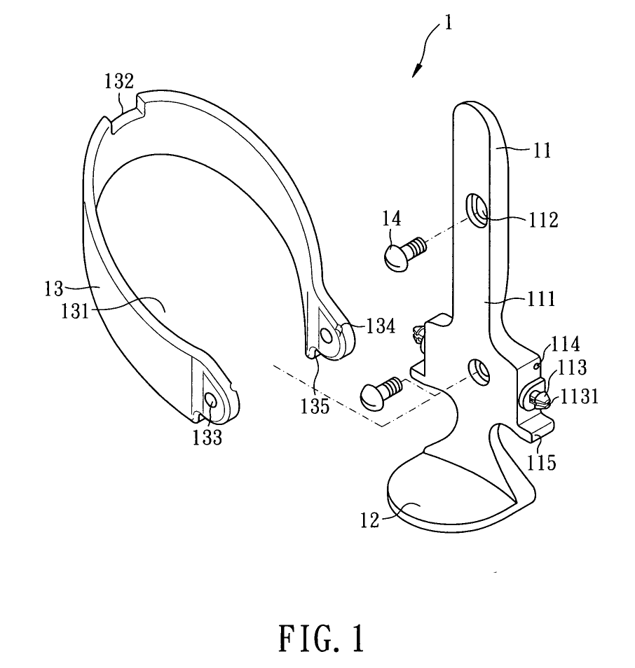

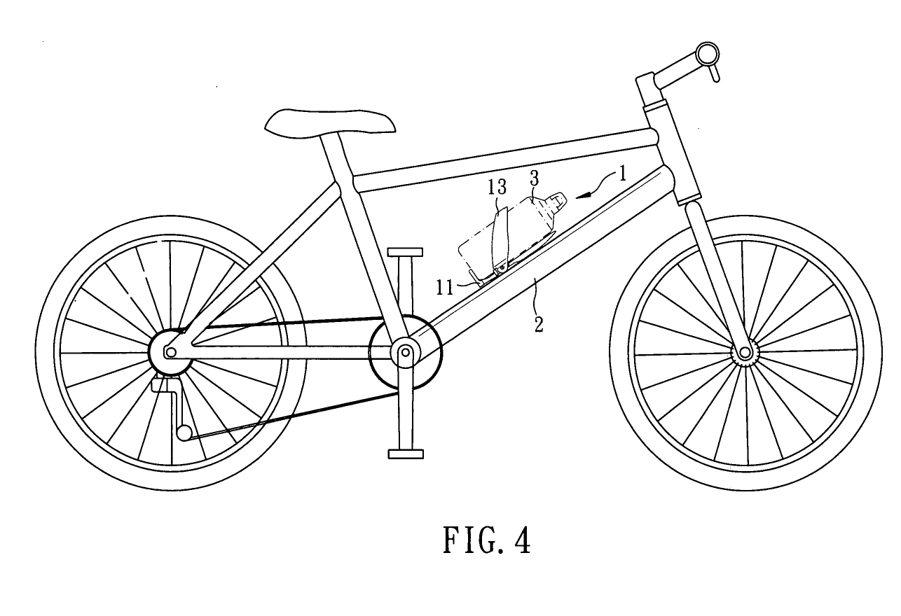

Referring to FIGS. 1 to 5, the bottle rack 1 for bicycles of the present invention is a generally L-shaped unit and comprises a base portion 11 and a holding portion 13. The base portion 11 includes an elongate first portion 111 and a second portion 12 which is a flat plate and is integrally connected to the first portion 111 at right angle. Of course, any suitable angle can be used between the first and second portions 111, 12. Two through holes 112 are defined through the first portion 111 and bolts 14 extend through the through holes 112 and fix the first portion 111 to the bicycle 2.

The holding portion 13 is a substantially U-shaped member and two ends of the holding portion 13 pivotably are connected to the base portion 11. Two connection members 113 extend from two sides of the first portion 111 and the two ends of the holding portion 13 have two holes 133 through which the two connection members 113 extend. Each of the connection members 113 includes an enlarged head and a slit 1131 is defined in the enlarged head so as to form two parts which are flexible to be squeezed toward each other. The holding portion 13 is able to be pivoted about the two connection members 113 relative to the first portion 111 so as to adjust the space between the holding portion 13 and the base portion 11, a water bottle 3 is positioned in the space. The two positioning bosses 114 and two ribs 115 extend from two sides of the first portion 111, the connection member 113 on each side of the first portion 111 is located between the positioning boss 114 and the rib 115. Two notches 134 are defined in two respective insides of the two ends of the holding portion 13, such that the two positioning bosses 114 are engaged with the notches 134 when the holding portion 13 is located at a first position. Two protrusions 135 extend from the two ends of the holding portion 13, the two protrusions 135 contact against the two ribs 115 when the holding portion 13 is located at a first position. The first position of the holding portion 13 allows a large water bottle 3 to be held between the holding portion 13.

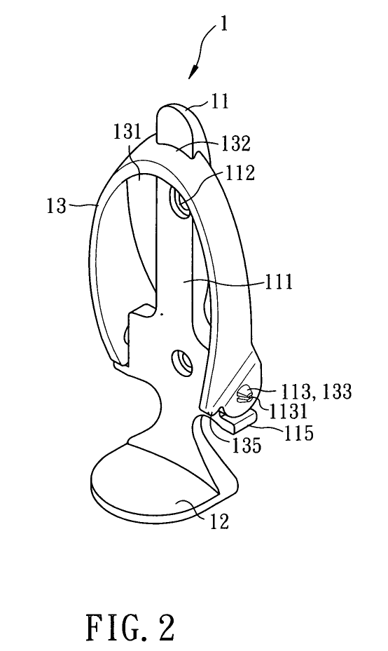

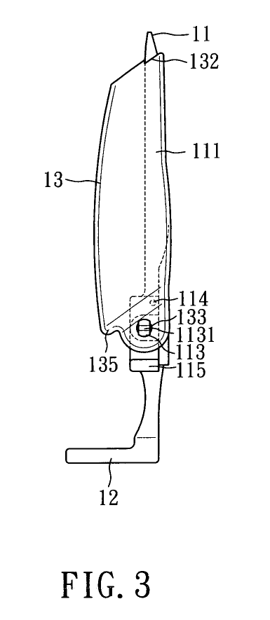

Further referring to FIGS. 2 and 3, a positioning recess 132 is defined in the holding portion 13 and the first portion 111 is engaged with the positioning recess 132 when the holding portion 13 is located at the second position. The second position of the holding portion 13 allows the holding portion 13 to be pivoted toward and engaged with the first portion 111 so that the bottle rack 1 becomes slim and is located parallel to the down tube of the bicycle 2.

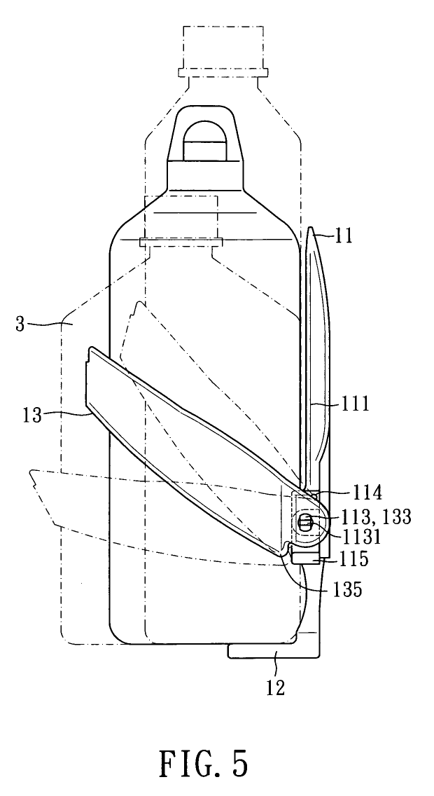

As shown in FIG. 5, the holding portion 13 can be pivoted any desired position to hold the water bottles 3 of different sizes. The number of the notches 134 can be more than one in each end of the holding portion 13 to position the holding portion 13 at different positions. Besides, the Two torsion springs (not shown) can be cooperated with the two ends of the holding portion 13 to let the holding portion 13 have proper clamp force to hold the water bottle 3 and the torsion springs allows the holding portion 13 to be located at the second position when no water bottle 3 is held.

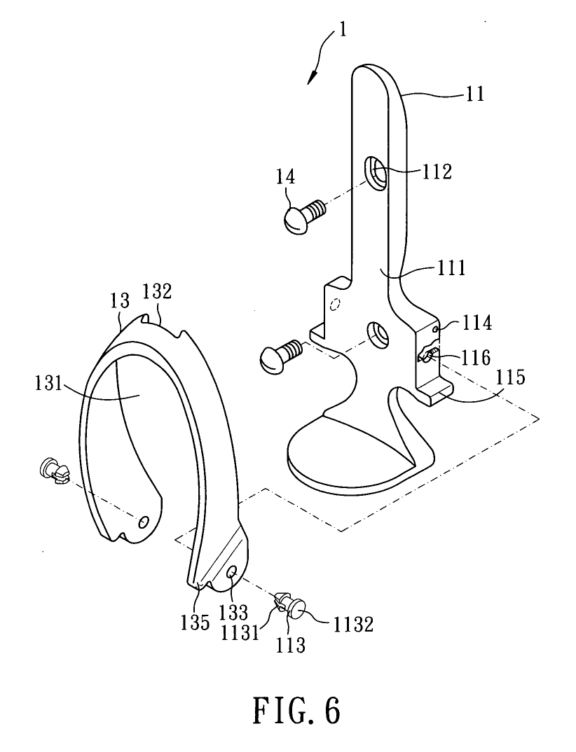

FIG. 6 shows another embodiment of the bottle rack 1 of the present invention wherein the connection members 113 are not integrally formed with the first portion 111. The first portion 111 includes two engaging holes 116 defined in the two sides thereof and the two ends of the holding portion 13 include two holes 133 defined therethrough. The two connection members 113 extend through the two holes 133 of the holding portion 13 and are engaged with the engaging holes 116 of the first portion 111. Each of the connection members 113 includes an enlarged head and an indication surface 1132 on two ends thereof, the enlarged head includes a slit 1131 defined therein so as to form two parts which are flexible to be squeezed toward each other. The indication surface 1132 may have color, a pattern or a logo thereon on

The bottle rack 1 of the present invention includes a pivotable holding portion 13 to adjust the space for water bottles 3 of different sizes, the holding portion 13 can be connected to the first portion 111 of the base portion 11 to avoid from being hit.

While we have shown and described the embodiment in accordance with the present invention, it should be clear to those skilled in the art that further embodiments may be made without departing from the scope of the present invention.

What is claimed is:

1. A bottle rack for a bicycle, comprising:
a base portion adapted to be fixed to the bicycle and including a first portion and a second portion which is located at an angle from the first portion, and
a holding portion having two ends thereof pivotably connected to the base portion.

2. The bottle rack as claimed in claim 1, wherein the second portion is a flat plate which is integrally connected to the first portion at right angle.

3. The bottle rack as claimed in claim 1, wherein two connection members extend from two sides of the first portion and the two ends of the holding portion have two holes through which the two connection members extend.

4. The bottle rack as claimed in claim 1, wherein two positioning bosses extend from two sides of the first portion and two notches defined in two respective insides of the two ends of the holding portion, the two positioning bosses are engaged with the notches when the holding portion is located at a first position.

5. The bottle rack as claimed in claim 1, wherein two ribs extend from two sides of the first portion and two protrusions extend from the two ends of the holding portion, the two protrusions contact against the two ribs when the holding portion is located at a first position.

6. The bottle rack as claimed in claim 1, wherein a positioning recess is defined in the holding portion and the first portion is engaged with the positioning recess when the holding portion is located at a second position.

7. The bottle rack as claimed in claim 1, wherein the first portion includes two engaging holes defined in two sides thereof and the two ends of the holding portion includes two holes defined therethrough, two connection members extend through the two holes of the holding portion and are engaged with the engaging holes of the first portion.

8. The bottle rack as claimed in claim 7, wherein each of the connection members includes an enlarged head and an indication surface on two ends thereof, the enlarged head includes a slit defined therein so as to form two parts which are flexible to be squeezed toward each other.

9. The bottle rack as claimed in claim 3, wherein each of the connection members includes an enlarged head and a slit is defined in the enlarged head so as to form two parts which are flexible to be squeezed toward each other.
